(19) United States
(12) Patent Application Publication
(10) Pub. No.: US 2004/0237665 A1
(43) Pub. Date: Dec. 2, 2004

(54) Measuring device for longitudinally moved strip and measuring method for process parameters of a strip conveyor system

(76) Inventors: Gert Mucke, Hilden (DE); Ernst Luhn, Haan (DE)

Correspondence Address: Andrew G. Kolomayets, Cook, Alex, McFarron, Manzo,, Cummings & Mehler, Ltd., 200 West Adams Street - Suite 2850, Chicago, IL, 60606, US

(21) Appl. No.: 10/844,042

(22) Filed: May 12, 2004

(30) Foreign Application Priority Data
May 14, 2003 (DE) 103 21 865.3

(51) Int. Cl. G01L 5/04

(52) U.S. Cl. 73/862.44

(57) ABSTRACT

The invention relates to a measuring method in particular for the strip tension and the line force of a strip conveyor system, in which the strip is guided so as to wrap partially around a corotating measuring roller, which has at least one pressure sensor for measuring a pressure acting on a surface section of the measuring roller, and guided through a gap formed between the measuring roller and a backing roller. The pressure acting on a surface section of the measuring roller is measured by means of the pressure sensor at least at two rotational positions of the measuring roller. The rotational angle of the measuring roller is measured relative to a reference position. The invention is based on the basic idea of measuring the variation of a pressure acting on a surface section of the measuring roller over at least part of the rotation of the measuring roller. The evaluation of the pressure variation permits precise determination of process parameters, in particular for those which are not given directly by a locally measured pressure value. For example, the force determined from a conversion of the pressure measured in the gap between measuring roller and backing roller is not the line force acting on the strip in the gap as a result of the setting forces of the rolls. The measured pressure value partly comprises compressive forces which are produced by the strip tension acting on the strip. The invention can compensate for this difference.

The invention relates to a measuring device for a longitudinally moved strip and a measuring method for a strip conveyor system. In particular, the invention relates to the technical field of strip tension measurement, strip profile measurement and line force measurement, for example on rolled strips, plastic strips, paper webs or board webs during the conveyance of such a strip over rolls/rollers and through a gap.

DE 199 20 133 A1 describes one of the possible areas of use. Here, a method of measuring the line force in the nip between a carrier drum and a wound reel is described. The carrier drum is formed as a measuring roller and has measuring elements in the form of piezo quartz elements, which are fitted to the circumferential surface of the rotating measuring roller. However, the line force in the gap between carrier drum and wound reel determined with such a measuring roller does not correspond to the line force actually acting on the strip in the nip as a result of the setting forces of the rolls.

Against this background, the invention is based on the object of providing a measuring device for a longitudinally moved strip and a measuring method for process parameters of a strip conveyor system which permit more precise measurement of the line force and, in addition, the measurement of further process parameters.

The object is achieved by the device and the method of the parallel claims. Advantageous refinements are specified in the subclaims.

The invention is based on the basic idea of measuring the variation of a pressure acting on a surface section of the measuring roller over at least part of the rotation of the measuring roller. The evaluation of the pressure variation permits precise determination of process parameters, in particular for those which are not given directly by a locally measured pressure value. For example, the force determined from a conversion of the pressure measured in the gap between measuring roller and backing roller is not the line force acting on the strip in the gap as a result of the setting forces of the rolls. The measured pressure value partly comprises compressive forces which are produced by the strip tension acting on the strip.

According to the invention, the measuring device has a measuring roller and a backing roller, the measuring roller having at least one pressure sensor for measuring the pressure acting on a surface section of the measuring roller. A gap is formed between measuring roller and backing roller. The measuring device is designed or arranged for a strip guidance system, in which the longitudinally moved strip is guided so as to wrap partly around the measuring roller and is guided through the gap. A rotary encoder is provided for measuring the rotational angle of the measuring roller relative to a reference position. The measuring roller rotates about its axis.

A longitudinally moved strip is a strip which is moved (conveyed) in the direction of its longitudinal extent.

By means of the pressure sensors of the measuring roller, the pressure acting on a surface section of the measuring roller can be measured during the rotation of the measuring roller. The rotary encoder permits the assignment of the measured pressure values to rotational angles which are defined with respect to a reference position, as a result of which the pressure variation relative to the reference position can be displayed.

Pressure sensors for measuring the pressure acting on a surface section of the measuring roller are understood to mean, in particular, pressure sensors having a piezo element. However, other pressure measuring sensors can also readily be used, for example displacement sensors whose measure result can be converted into a pressure value. The pressure sensors can be arranged wherever they are able to determine the pressure acting on a defined surface section of the measuring roller. In particular, the pressure sensors are arranged directly at the measuring roller surface, on the measuring roller surface or at a short distance underneath the measuring roller surface. For the specific construction of a measuring roller and, in particular, the arrangement of the pressure sensors, reference is made in particular, to DE 297 21 085 U, DE 199 18 699 A1, DE 196 16 980 A1. The parts of the text of the aforementioned documents relating to the construction of a measuring roller and the arrangement of pressure sensors count as parts of the description of this application.

The measuring device is constructed in such a way that the longitudinally moved strip wraps partly around the measuring roller and is guided through the gap. The partial wrapping of the measuring roller can be adjusted by the manner in which the strip is fed to the measuring roller. For instance, the point at which the strip runs onto the measuring roller can be defined by the arrangement of deflection rollers. An angle of less than 180°, preferably of 170 to 150°, in particular 160°, has proven to be particularly advantageous as the wrap angle, although other wrap angles can readily be provided.

Conventional rotary encoders can be used as the rotary encoders for measuring the rotational angle of the measuring roller. In particular, rotary encoders arranged on the measuring roller hub can be used. For example, however, optical measuring methods which register codes on the surface of the measuring roller can also be used.

The gap between measuring roller and backing roller is understood to mean an interspace between the rollers, in which the strip rests on both rollers. In this connection, resting on the backing roller is also understood to mean resting on sections of strip already wound onto a backing roller formed as a wound reel.

When a single pressure sensor is used, good results are already determined, in particular in determining the average strip tension and the average line force in the gap. This applies quite particularly when the pressure sensor is fitted in an axial position of the measuring roller in which—for example determined by means of comparative or prior trials—a value corresponding well to the averages is regularly present. The measuring roller particularly preferably has a plurality of pressure sensors. These can be arranged in such a way that they are able to measure the pressure on surface sections arranged beside one another in the axial direction and/or circumferential direction of the measuring roller. In this case, however, the surface sections do not necessarily have to be arranged immediately adjacent to one another. The pressure sensors can be arranged in such a way that the surface sections respectively associated with them lie in a line parallel to the measuring roller axis.

Two pressure sensors can be connected together with the electrical connections to form a parallel circuit. In this way, in particular a reduction in the measuring signals to be processed is possible. In particular, use is made for this purpose of pressure sensors which are arranged in such a way that in each case there is only one pressure sensor in the wrap area of the measuring roller. The two pressure sensors are preferably arranged in such a way that they measure the pressure of surfaces offset from each other by 180°. In particular in order to measure a strip with profile deviations, the measuring roller can be coated with a resilient material. This material adapts to the profile shape of the strip and permits a precise pressure measurement. Likewise, other connections of more pressure sensors can be made which reduce the number of measuring channels. In making the connection, use can be made in particular of the fact that pressure sensors distributed over the circumference of the measuring roller in the circumferential direction are not simultaneously arranged in the wrap area and therefore—depending on the sensor type—do not simultaneously supply measured signals with values greater than zero.

The backing roller can be moved relative to the measuring, roller. This permits, for example, a control system in which a defined line force can be adjusted. For this purpose, for example, lifting cylinders can be used. Likewise, one of the rollers can be arranged at one end of a rocker whose other end can be loaded with weights, and also other devices can be used for displacing and pivoting the rollers.

The backing roller is preferably formed as a wound reel. The measuring device is then used in particular to measure the line force as the strip is wound up. With an increasing number of turns on the wound reel, the axial distance between wound reel and measuring roller can be enlarged, so that a defined gap is maintained.

The measuring roller particularly preferably has a resilient coating. This is in particular resilient in such a way that it can adapt to the surface profile of the strip. The measuring roller is preferably coated. with rubber or polyurethane.

The measuring device according to the invention is used. in particular for determining the strip tension, the actual line force, the strip profile and the friction existing between the measuring roller surface and the strip surface. It can be used in control loops. It is used in particular wherever process parameters of a longitudinally conveyed strip are determined, for example in processes with hot strip, cold rolled strip, paper or board webs, plastic films, films, woven fabrics, textiles and others.

The measuring method according to the invention for process parameters of a strip conveyor system provides in particular for the strip to be guided so as to wrap partially around a corotating measuring roller, which has at least one pressure sensor for measuring a pressure acting on a surface section of the measuring roller, and guided through a gap formed between the measuring roller and a backing roller. The pressure acting on a surface section of the measuring roller is measured by the pressure sensor at least at two rotational positions of the measuring roller, and the rotational angle of the measuring roller relative to a reference position is determined.

Process parameter is understood to mean in particular the average strip tension acting on the entire strip, the specific strip tension acting on a strip-wide strip, the line force (nip force) and the friction existing between the measuring roller surface and the strip surface. However, it is readily possible, on the basis of the information provided by the measuring method, to determine further process parameters of a strip conveyor system. A strip conveyor system is understood to mean, in particular, the movement of a strip along its longitudinal direction.

The pressure measurement can be carried out discretely at individual rotational positions of the measuring roller. The pressure sensor preferably measures continuously, at least over a rotational section of the measuring roller.

The pressure acting on a surface section of the measuring roller can be measured by means of the pressure sensor if this surface section is located in the region of, preferably directly in, the gap. This permits, in particular, the determination of the line force (nip force) acting on the strip in the gap. When the relevant surface section is located in the region of the gap—given knowledge of the position of the gap relative to the reference position—it is possible for it to be determined on the basis of the measured rotational angle associated with the pressure variation. Alternatively, in the case of discontinuous measurement, a measurement can be triggered when it is established, on the basis of the measured rotational angle, that the pressure sensor associated with the surface section is located in the region of the gap.

Likewise, the determination of the line force acting on the strip in the gap can be calculated by forming the maximum value from the series of pressure values determined during one rotation or a part rotation of the measuring roller. This series of pressure values recorded during the rotation or a part rotation of the measuring roller can consist of the pressure values measured at two rotational positions of the measuring roller, one rotational position being located in the region of the gap. In the case of continuous pressure measurement over a rotational section of the measuring roller, preferably over the wrap area, the formation of the maximum value can be determined by means of a functional approximation of the pressure variation using conventional mathematical means and determining the maximum value through the second derivative of this functional approximation. Other mathematical methods for determining the maximum value from the series of pressure values can likewise be employed.

In particular in order to determine the variation of the line force (line force profile) oriented in the direction of the measuring roller axis or, for example, in order to determine the pressure variation acting on the surface of the measuring roller outside the gap, the pressure acting on surface sections arranged beside one another in the axial direction of the measuring roller can be measured by a plurality of pressure sensors.

The line force profile determined can be converted into a surface profile of the strip.

According to a preferred embodiment, by means of a pressure sensor, the pressure acting on a surface section can be measured when the surface section is located outside the gap and, from the measured value, the strip tension (specific strip tension) acting on the strip-wide section associated with the surface section can be calculated. By means of a plurality of pressure sensors, the pressure acting on surface sections arranged beside one another in the axial direction of the measuring roller can be measured when the respective surface section is outside the gap. The pressure values determined in this way can, for example, also be used for averaging in order to determine a strip tension. From the strip tension variation pointing in the axial direction, the surface profile of the strip can likewise be calculated.

It has been shown that the variation of the measured pressure during the rotation exhibits a rise from 0 to a first plateau value. This reflects the course of the sensor coverage from the uncovered to the fully covered state by the strip. From this first plateau value, the radial force variation in the region of the coverage decreases as the rotational angle increases from the run-on point. From this, it is possible to determine the friction acting between the surface of the strip and the surface of the measuring roller. In addition to other conceivable, computing methods, the friction can be determined particularly simply in that, from the measured pressure values measured continuously over a rotational section of the measuring roller, a pressure variation is determined, the pressure variation is approximated by a mean straight line and the friction existing between the measuring roller surface and the strip surface is determined from the slope of the mean straight line.

The determination of the friction permits conclusions to be drawn about the material surface of the strip conveyed. If the friction is observed over a relatively long time, this permits an assessment of the quality of the measuring roller surface.

In particular, according to the invention, a measuring device for a longitudinally moved strip, having a measuring roller which has at least one pressure sensor for measuring a pressure acting on a surface section of the measuring roller and in which the longitudinally moved strip is guided so as to wrap partly around the measuring roller and a rotary encoder is provided for measuring the rotational angle of the measuring roller relative to a reference position, can be used for the purpose of determining the friction between strip surface and measuring roller surface. For this purpose, the variation of the pressure values measured over a rotational area is analyzed, as described previously, for example.

The strip tension determined can be used for the purpose of determining more precisely the line force actually acting on the strip. In this way, the line force determined in the gap can be reduced by the strip tension determined. This gives the line force actually acting on the strip.

The process parameters determined, in particular the measured line force and the measured strip tension, are preferably used in a process control system. For example, by moving the measuring roller in relation to the backing roller, the line force can be set. This can be done by means of axially parallel movement of the rollers in relation to each other or—depending on the line force profile to be set—by pivoting or tilting the rollers.

In the following text, the invention will be explained in more detail using a drawing merely showing exemplary embodiments. In the drawing

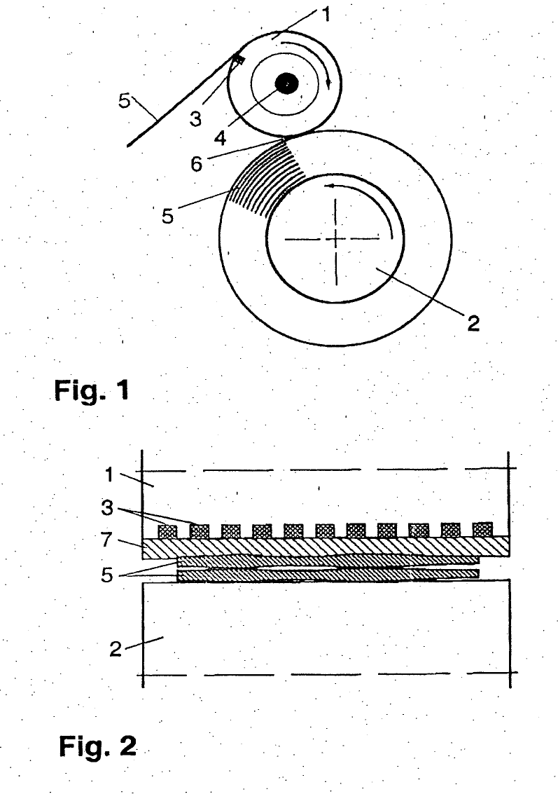

FIG. 1 shows the measuring device according to the invention in a schematic side view,

FIG. 2 shows the gap formed between measuring roller and backing roller of the measuring device according to FIG. 1 in a plan view,

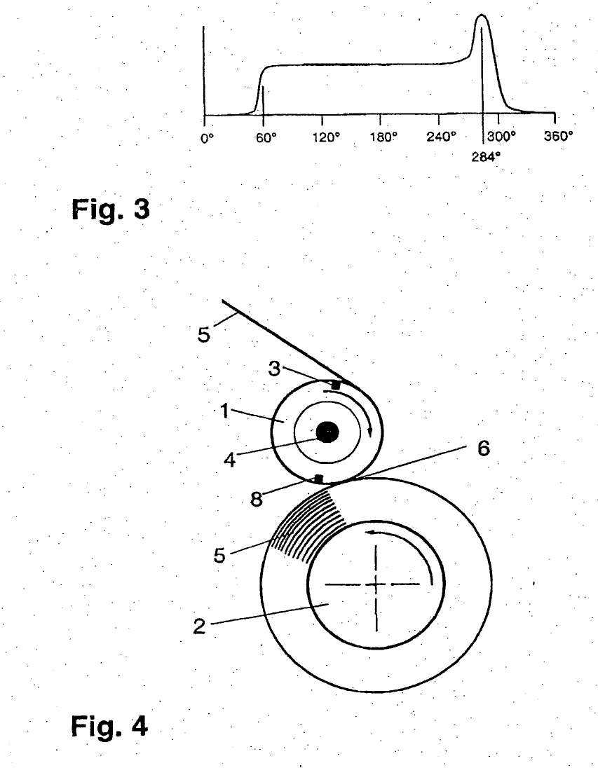

FIG. 3 shows a measured signal variation graph of the values measured by the pressure sensor of the measuring device according to FIG. 1,

FIG. 4 shows a further embodiment of a measuring device according to the invention in a schematic side view and

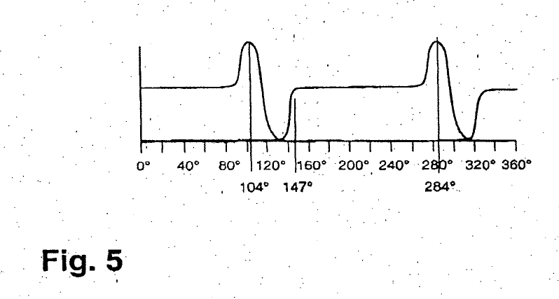

FIG. 5 shows a measured signal variation graph of the values measured by the pressure sensor of the measuring device according to FIG. 4.

The measuring device illustrated in FIG. 1 has a measuring roller 1 and a backing roller 2 formed as a wound reel. The measuring roller 1 has a plurality of pressure sensors 3. These are arranged on the surface of the measuring roller 1 in a line parallel to the measuring roller axis (FIG. 2). The pressure sensors 3 pick up the pressure acting on a surface section of the measuring roller 1 associated with them. In each case a rotary encoder 4 is arranged on the hub of the measuring roller 1. Said encoder measures the rotational position of the measuring roller 1 as a rotational angle relative to a fixed reference point.

The measuring device is arranged in such a way that the strip 5 conveyed and to be wound up is guided around the measuring roller 1 with a wrap of 224° and through the gap 6 formed between the measuring roller 1 and backing roller 2. After passing through the gap 6, the strip is wound onto the backing roller 2. Mountings for the measuring roller 1 and the backing roller 2, not illustrated, are formed in such a way that the measuring roller 1 and the backing roller 2 can be moved toward each other and away from each other while maintaining their axially parallel alignment.

As FIG. 2 reveals, the pressure sensors 3 are arranged beside one another in the axial direction of the measuring roller 1. The measuring roller 1 is provided with a coating 7. This consists of a resilient material and adapts to the surface profile of a layer of strip resting on it. FIG. 2 shows that, after passing through the gap, the strip is wound up onto the backing roller 2. In the gap between the measuring roller 1 and the backing roller 2, following increasing winding of the strip, there are layers of strip already wound up and the layer of strip currently to be measured at that time. This layer of strip currently to be measured is the layer of strip resting on the measuring roller 1 in FIG. 2.

The embodiment of the measuring device according to the invention that is illustrated in FIG. 4 is constructed in such a way that the wrap angle of the strip 5 around the measuring roller 1 is lower, namely about 140°. The measuring roller 1 has mutually opposite pressure sensors 3, 8. Depending on the wrap of the measuring roller, said sensors are arranged in such a way that there is always only one of the sensors 3, 8 in a region around which the strip wraps.

As the strip 5 runs around the measuring roller 1, the latter rotates with it. The pressure sensor 3 follows the strip section resting on it and measures the compressive force acting in this surface region as a result of the contact between the strip section and the measuring roller 1. The pressure sensor 3 measures the composite force continuously during the rotation of the measuring roller 1. A rotational angle of the measuring roller, measured by the rotary encoder 4, is assigned to the measured signals from the pressure sensor. The result is the representation of the measured signal variation relative to a selected reference point according to FIG. 3. FIG. 3 shows the measured signal variation in relation to the rotational angle of the measuring roller.

As FIG. 3 shows, the strip runs onto the measuring roller at the relative rotational angle of 60°. This means that the pressure sensor can establish that the strip runs on at this point. The measured signal variation illustrated in FIG. 3 shows a steep rise to a first pressure level in this area.

Disregarding frictional forces acting between the strip and the measuring roller surface, the compressive forces produced solely by the strip tension during the further guidance of the section. of strip observed by the pressure sensor 3 around the measuring roller axis initially remain constant. As the gap 6 is passed, the pressure sensor 6 registers a pressure peak, as can be seen from FIG. 3. After running out of the gap, the strip 5 leaves the measuring roller, so that the signal registered by the pressure sensor drops to zero.

FIG. 5 illustrates the variation of a measured signal which results when the signal lines of the pressure sensors 3 and 8 are connected in parallel with each other. FIG. 5 shows the measured signal variation in relation to the rotational angle of the measuring roller. Here, the variation already described with respect to FIG. 3 is repeated during a complete rotation of the measuring roller. The measured signal variation shows the addition of the signals determined by the pressure sensors 3 and 8. Since in each case one of the pressure sensors is not in the wrap area, the pressure signal determined by it is zero. As a result of this arrangement, the number of signal channels can be reduced, since only one channel is needed to transmit the measured signals from two specifically arranged pressure sensors.

From the measured signal variations illustrated in FIGS. 3 and 5, a plurality of process parameters may be determined. The pressure value, which is constant in the region between the run-on to the measuring roller and the passage through the gap, neglecting the friction, may be converted in a known way into the specific strip tension acting on the strip region associated with the pressure sensor. By averaging the specific strip tensions determined in this way from the strip sections observed by the pressure sensors arranged beside one another, the average strip tension can be determined. Furthermore, the evaluation of the relative differences of the specific strip tensions on the individual strip-width positions makes a statement possible about the strip tension profile or the surface profile of the strip.

The pressure maximum measured at the passage through the gap 6 may be converted into the exact line force (nip force) acting on the strip by taking into account the strip tension already previously prevailing. In this way, line force undistorted by the strip tension can be determined. By means of analysis of the different rolling forces measured over the strip width, the line force profile in the nip or the surface profile of the strip can be determined.

The process parameters determined, for example the specific strip tension, the average strip tension of the axial strip tension variation, the absolute line force, the corrected line force, the line force variation and/or the surface profile variation of the strip, can be set within the context of a control system for controlling processing steps of the strip. For example, by means of the measured values determined, a line force which corresponds to a predefined value and predefined variation can be adjusted. Likewise, actuating variables during the strip production, for example during the casting of the strip, and in particular control of the profile, flatness and thickness of the strip, can be influenced by the measured results.

1. A measuring device for a longitudinally moved strip (5), having a measuring roller (1) and a backing roller (2), in which
the measuring roller (1) has at least one pressure sensor (3, 8) for measuring the pressure acting on a surface section of the measuring roller (1),
a gap (6) is formed between the measuring roller (1) and backing roller (2),
the longitudinally moved strip (5) is guided so as to wrap partly around the measuring roller (1) and is guided through the gap (6),
a rotary encoder (4) is provided for measuring the rotational angle of the measuring roller (1) relative to a reference position.

2. The measuring device as claimed in claim 1, characterized in that the measuring roller (1) has a plurality of pressure sensors (3, 8), which are arranged in such a way that they measure the pressure in each case acting on surface sections arranged beside one another in the axial direction of the measuring roller.

3. The measuring device as claimed in claim 1, characterized in that the pressure sensor (3, 8) contains a piezo element.

4. The measuring device as claimed in one claim 1, characterized in that two pressure sensors (3, 8) have electrical connections and these connections are connected together to form a parallel circuit.

5. The measuring device as claimed in claim 4, characterized in that the two pressure sensors (3, 8) are arranged in such a way that they measure the pressure acting on surface sections offset from each other by 180°.

6. The measuring device as claimed in claim 1, characterized in that the measuring roller (1) is coated with a resilient material.

7. The measuring device as claimed in claim 1, characterized in that the backing roller (2) can be moved relative to the measuring roller (1).

8. The measuring device as claimed in claim 1, characterized in that the backing roller (2) is formed as a wound reel.

9. A measuring method for process parameters of a strip conveying system, characterized in that
the strip (5) is guided so as to wrap partially around a corotating measuring roller (1), which has at least one pressure sensor (3, 8) for measuring the pressure acting on a surface section of the measuring roller (1), and is guided through a gap (6) formed between the measuring roller (1) and a backing roller (2),
the pressure acting on a surface section of the measuring roller (1) is measured by the pressure sensor (3, 8) at least at two rotational positions of the measuring roller (1) and
the rotational angle of the measuring roller (1) relative to a reference position is measured.

10. The measuring method as claimed in claim 9, characterized in that the pressure sensor (3, 8) measures continuously, at least over a rotational section of the measuring roller (1).

11. The measuring method as claimed in claim 9, characterized in that the measured values from the pressure sensor (3, 8) are in each case assigned to a measured rotational angle.

12. The measuring method as claimed in claim 9, characterized in that the pressure acting on a surface section of the measuring roller (1) is measured by means of the pressure sensor (3, 8) if the surface section is located in the region of the gap (6).

13. The measuring method as claimed in claim 12, characterized in that the line force acting on the strip (5) in the gap (6) is calculated by forming the maximum value from the series of pressure values determined during one rotation or a part rotation of the measuring roller (1).

14. The measuring method as claimed in claim 9, characterized in that the pressure acting in each case on surface sections arranged beside one another in the axial direction of the measuring roller (1) is measured by a plurality of pressure sensors (3, 8).

15. The measuring method as claimed in claim 14, characterized in that
by means of the pressure sensors (3, 8), the pressure acting on the surface sections arranged beside one another in the axial direction is measured when the respective surface section is located in the region of the gap (6),
in each case the line force acting in the gap (6) on the width section of the strip (5) associated with the surface section is calculated by forming the maximum value from the series of pressure values from the associated pressure sensor (3, 8) determined during one rotation or a part rotation of the measuring roller (1), and
the line force profile over the width of the strip (5) is determined from the line force values assigned to the width sections.

16. The measuring method as claimed in claim 15, characterized in that the surface profile of the strip (5) is calculated from the line force profile.

17. The measuring method as claimed in claim 9, characterized in that, by means of pressure sensors (3, 8), the pressure acting on a surface section is measured when the surface section is located outside the gap (6), and the strip tension acting on the strip width section associated with the surface section is calculated from the measured value.

18. The measuring method as claimed in claim 17, characterized in that, by means of a plurality of pressure sensors (3, 8), the pressure in each case acting on surface sections arranged beside one another in the axial direction of the measuring roller (1) is measured when the respective surface section is located outside the gap (6), and the average strip tension acting on the strip (5) is calculated from the measured values.

19. The measuring method as claimed in claim 18, characterized in that the strip tension variation acting on the strip (5) is measured from the measured values.

20. The measuring method as claimed in claim 19, characterized in that the surface profile of the strip (5) is calculated from the strip tension variation.

21. The measuring method as claimed in claim 9, characterized in that a pressure variation is determined from the measured pressure values measured over a rotational section of the measuring roller, the pressure variation is approximated by a mean straight line, and the friction existing between the measuring roller surface and the strip surface is determined from the slope of the mean straight line.
